(19) United States
(12) Patent Application Publication
(10) Pub. No.: US 2022/0391861 A1
(43) Pub. Date: Dec. 8, 2022

(54) INFORMATION PROCESSING SYSTEM, INFORMATION PROCESSING DEVICE, AND INFORMATION PROCESSING METHOD

(71) Applicant: SONY GROUP CORPORATION, TOKYO (JP)

(72) Inventors: KOKI TAKAHASHI, TOKYO (JP); YOSHIHIKO IKENAGA, TOKYO (JP); MASAAKI ISOZU, TOKYO (JP); KAZUHIRO WATANABE, TOKYO (JP)

(21) Appl. No.: 17/755,746

(22) PCT Filed: Nov. 10, 2020
(86) PCT No.: PCT/JP2020/041925

§ 371 Date: May 6, 2022

(30) Foreign Application Priority Data
Nov. 15, 2019 (JP) 2019-206861

(51) Int. Cl. G06Q 20/06; G06Q 20/38

(52) U.S. Cl. CPC G06Q 20/0658; G06Q 20/389

(57) ABSTRACT

It is made possible to maintain confidentiality of data in a service using a public-type blockchain. An information processing system according to an embodiment includes: a service providing unit (200) that provides a predetermined service to a user; a recording unit (200) that holds first registration information registered in the service providing unit by the user according to the predetermined service, and a monitoring unit (210) that monitors whether first transaction data including first identification information for specifying the predetermined service is recorded in a public blockchain, wherein the monitoring unit transmits the first transaction data to the service providing unit, and the service providing unit generates data for recording second transaction data for approving the first transaction data into the public blockchain in a case where second registration information included in the first transaction data received from the monitoring unit matches the first registration information held in the recording unit.

### FIELD

The present disclosure relates to an information processing system, an information processing device, and an information processing method.

### BACKGROUND

In recent years, blockchain technology capable of realizing various kinds of service such as financial service and certificate issuing service online has attracted attention. Especially, blockchains that can develop a smart contract, such as Ethereum and Eris, have attracted more attention due to extensibility of service that can be realized.

### CITATION LIST

### Patent Literature

Patent Literature 1: WO 2017/090329

### SUMMARY

### Technical Problem

As blockchains, there are a private type, a consortium type, and a public type. The consortium type is a blockchain that can be used only by one or more specific participants, and the private type is a blockchain that can be used only in a specific organization. In the consortium type and the private type, only participants permitted by an administrator are allowed to record data in a blockchain.

On the other hand, the public type is a blockchain with no administrator, and can be used by anyone. This means that in the public type, any participant can view data written in the blockchain. Thus, in service using the public-type blockchain, there is a problem that information that a user does not want to disclose is disclosed via the blockchain by an App provided by a service provider.

Thus, the present disclosure proposes an information processing system, information processing device, and information processing method capable of preventing the information, which the user does not want to disclose, from being disclosed by the App provided by the service provider.

### Solution to Problem

To solve the above-described problem, an information processing system according to one aspect of the present disclosure comprises: a service providing unit that provides a predetermined service to a user; a recording unit that holds first registration information registered by the user in the service providing unit according to the predetermined service, and a monitoring unit that monitors whether first transaction data including first identification information for specifying the predetermined service is recorded in a public blockchain, wherein the monitoring unit transmits the first transaction data to the service providing unit, and in a case where second registration information included in the first transaction data received from the monitoring unit matches the first registration information held in the recording unit, the service providing unit generates data for recording second transaction data for approving the first transaction data into the public blockchain.

### BRIEF DESCRIPTION OF DRAWINGS

FIG. 1 is a view for describing an outline of a blockchain.

FIG. 2 is a block diagram illustrating a schematic configuration example of an information processing system according to one embodiment of the present disclosure.

FIG. 3 is a sequence diagram illustrating an example of a flow until a user records application information in a blockchain according to the one embodiment of the present

### DISCLOSURE

FIG. 4 is a sequence diagram illustrating an example of a flow until a service provider A approves the application information recorded in the blockchain according to the one embodiment of the present disclosure.

FIG. 5 is a flowchart illustrating an example of an operation of specifying unapproved transaction data according to the one embodiment of the present disclosure.

FIG. 6 is a sequence diagram illustrating an example of a flow until a third party acquires a certificate of the application information recorded in the blockchain from an Ethereum network according to the one embodiment of the present disclosure.

FIG. 7 is a view illustrating an example of registration information according to the one embodiment of the present disclosure.

FIG. 8 is a view illustrating an example of information recorded in the service provider A according to the one embodiment of the present disclosure.

FIG. 9 is a view illustrating an example of information transmitted from a server of the service provider A to a terminal of the user according to the one embodiment of the present disclosure.

FIG. 10 is a view illustrating an example of application information according to the one embodiment of the present disclosure.

FIG. 11 is a view illustrating an example of transaction data generated by a smart contract according to the one embodiment of the present disclosure.

FIG. 12 is a view illustrating an example of unapproved transaction data transmitted from a monitoring unit to the server according to the one embodiment of the present

### DISCLOSURE

FIG. 13 is a view illustrating an example of approval information according to the one embodiment of the present disclosure.

FIG. 14 is a view illustrating an example of the transaction data having contents indicating approval according to the one embodiment of the present disclosure.

FIG. 15 is a view illustrating an example of the certificate issued by the smart contract according to the one embodiment of the present disclosure.

FIG. 16 is a block diagram illustrating an example of a configuration of an information processing device according to the one embodiment of the present disclosure.

FIG. 17 is a view for describing an example of a hardware configuration of the information processing device according to the one embodiment of the present disclosure.

### DESCRIPTION OF EMBODIMENTS

Hereinafter, one embodiment of the present disclosure will be described in detail on the basis of the drawings. Note that in the following embodiment, overlapped description is omitted by assignment of the same reference sign to identical parts.

Also, the present disclosure will be described in the following order of items.

1. Introduction

1.1 Outline of blockchain

1.2 Outline of Ethereum

1.3 Recording and mining of new block by using smart contract

2. One embodiment

2.1 Configuration example of information processing system

2.2 Operation example of certificate issuing service

2.2.1 Flow until user a records application information in blockchain

2.2.2 Flow until service provider A approves application information recorded in blockchain

2.2.2.1 Operation example of specifying unapproved transaction data by monitoring unit 210

2.2.3 Flow until third party acquires certificate of application information recorded in blockchain from Ethereum network

3. Schematic configuration example of information processing device

4. Hardware configuration example of information processing device

5. Program according to present embodiment

6. Conclusion

1. Introduction

In one embodiment of the present disclosure, a blockchain that is a type of distributed peer-to-peer database distributed in a peer-to-peer network (also referred to as peer-to-peer distributed file system) is utilized. Thus, first, an outline of the blockchain will be described.

1.1 Outline of Blockchain

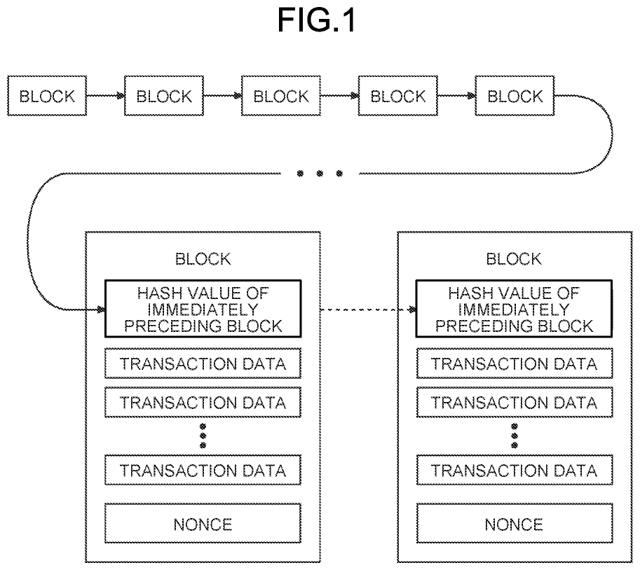

As illustrated in FIG. 1, the blockchain is data having a structure in which a plurality of blocks is connected like a chain. In each block, one or more pieces of target data may be stored as transaction data. Each piece of transaction data is made to be electronic, for example, by utilization of a private key of a user who requests recording of this transaction data, and is shared in the entire blockchain.

Each block includes, for example, a hash value of an immediately preceding block and a value called a nonce in addition to all pieces of transaction data shared by all the blocks. The hash value of the immediately preceding block is information used to determine whether the block is a “correct block” that is correctly connected from the immediately preceding block. The nonce is information used to prevent spoofing in authentication using the hash value, and tampering is prevented by inclusion of a nonce unique to each block. The nonce is, for example, a character string, a digit string, or data indicating a combination thereof.

As described above, such a blockchain includes, for example, a public type that can be used by an unspecified large number of network participants (hereinafter, simply referred to as participant), a consortium type that can be used only by one or more specific participants, and a private type that can be used only in a specific organization. In the following embodiment, a case where the public-type blockchain is adopted will be exemplified. However, the blockchain in the following embodiment is not limited to the public type, and may be the consortium type or the private type.

1.2 Outline of Ethereum

Also, in the following embodiment, among blockchains, platforms capable of automatically performing smooth verification, enforcement, execution, negotiation, and the like of a contract by the smart contract are used. Although blockchains such as Ethereum and Eris exist as such platforms, a case where Ethereum is used will be exemplified in the following embodiment.

Ethereum is a name of a platform for building distributed applications (DApps) and smart contracts, and is a generic term for related open source software projects. In Ethereum, an execution history of the smart contract is recorded in the blockchain as transaction data on a peer-to-peer network (hereinafter, simply referred to as P2P network) called an Ethereum network.

Also, Ethereum has a Turing-complete programming language that describes the smart contract. The participants can record any DApps or smart contract in the blockchain on the P2P network and perform execution thereof.

When the smart contract is recorded in the blockchain in Ethereum, three steps of “declaration”, “compilation”, and “deployment” are required. A participant who describes a source code of the smart contract performs compilation thereof, and transmits a compiled code to a mining pool on the P2P network. The mining pool is a region in which data waiting for mining is stocked.

When data is stocked in the mining pool, a server that manages the mining pool on the P2P network provides a block header other than a nonce to the data and generates a block.

Among the participants, a participant called a miner performs mining of a block, mining of which is not completed, for a reward of Ethereum internal currency (token) called “ETHER”.

When a correct nonce is found in the mining by the miner, a block in the mining pool is addressed and broadcast throughout the P2P network. As a result, the smart contract is successfully deployed to the blockchain.

In Ethereum, with such a structure, it becomes possible to execute a program and share a result thereof with the entire P2P network as an execution environment without relying on a specific central management organization.

1.3 Recording and Mining of New Block by Using Smart Contract

In public-type Ethereum, in a case where a new block is recorded in the blockchain by utilization of the smart contract, a user who is a participant accesses the P2P network and calls the smart contract. To call the smart contract, it is necessary to pay a reward called “GAS”. ETHER is used for GAS in Ethereum.

The called smart contract generates new transaction data from an execution history thereof. The smart contract then arranges the newly generated transaction data in the mining pool on the P2P network. The transaction data arranged in the mining pool is provided with a block header and converted into a block.

One or more miners who are the other participants execute operation of specifying a nonce satisfying a predetermined condition with respect to the block arranged in the mining pool. This operation corresponds to mining. For example, by executing mining according to proof of work (PoW), that is one kind of consensus algorithm, the miner acquires a reward corresponding to a result thereof.

Specifically, the miner specifies a value of a nonce with which a solution acquired by an input of data, which is acquired by addition of an unknown nonce to a target block, to a predetermined hash function satisfies a predetermined condition. In order to specify the nonce, a method of acquiring a solution by substituting all possible values in a brute-force manner is generally used.

A miner who successfully specifies the nonce publishes a value of the specified nonce on the P2P network. The published nonce is checked by the other miners. In a case where the published nonce is correct, this nonce is provided to the target block and the block including the correct nonce is broadcast over the P2P network and recorded in the blockchain. In addition, to the miner who first finds and publishes the correct nonce, a part of ETHER is distributed as a reward thereof from the GAS paid by the users.

### 2. One Embodiment

Next, an information processing system, an information processing device, and an information processing method according to one embodiment of the present disclosure will be described in detail with reference to the drawings.

In the present embodiment, a case where an information processing system configured to issue a certificate of information registered by the user a in the service provider A to a specific third party (hereinafter, simply referred to as third party) via the P2P network is built by utilization of public-type Ethereum will be described with an example. Note that the certificate issued in the present embodiment is not limited to a certificate of achievement, a certificate of qualification, or the like, and various certificates can be applied as long as the certificates certify certain information is authentic.

### 2.1 Configuration Example of Information Processing System

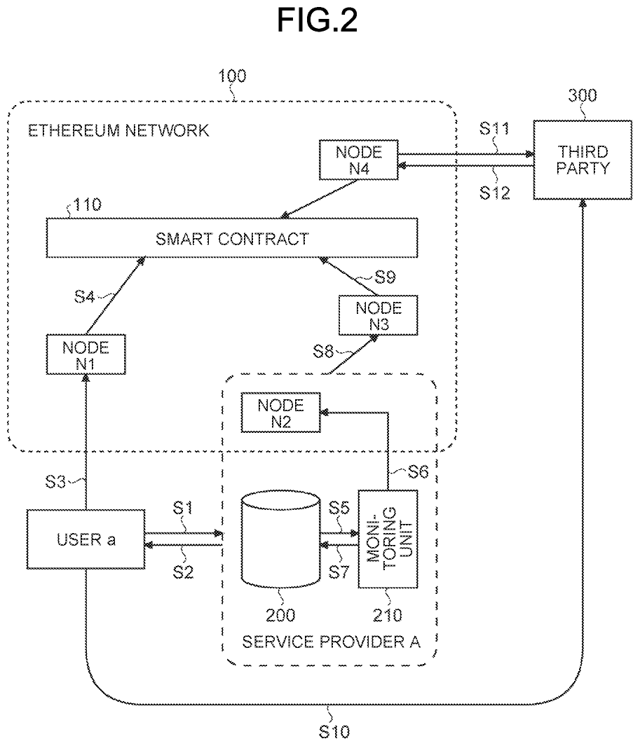

FIG. 2 is a block diagram illustrating a schematic configuration example of the information processing system according to the present embodiment. As illustrated in FIG. 2, the information processing system includes the user a, the service provider A, an Ethereum network 100, and a third party 300.

Here, the user a in the present description may be various individuals, corporations, other groups, or the like that may request issuance of a certificate to a third party, such as a student, an adult, a school, a company, or a union. The service provider A may be, for example, a service provider or the like that provides an application (hereinafter, referred to as App) that records and manages information registered by the user a and information given to the user a (hereinafter, referred to as registration information). The third party may be, for example, various individuals, corporations, other groups, or the like that may request issuance of the certificate related to the registration information, such as a teacher, a school, a company, or a union.

Note that the “registration information” in the present description is information registered by the user a into the service provider A, and is various kinds of information such as a grade of a test or curriculum, and activity/business contents of the user. The registration information may be information that the user a does not want others other than the service provider A and the third party to know, that is, information with high confidentiality for the user a. Also, the “application information” (described later) is information including the registration information, and may be information recording of which into the Ethereum network 100 is applied by the user a.

The Ethereum network 100 is the P2P network built by utilization of public-type Ethereum, and includes one or more nodes N1, N2, N3, N4, . . . (hereinafter, referred to as ‘node N’ in a case where individual nodes are not distinguished) and a smart contract 110.

The node N is a participant participating in the Ethereum network 100, and may call the smart contract 110, perform mining, and record new transaction data in a blockchain, for example.

The smart contract 110 is a contract deployed on the Ethereum network 100 and is, in the present embodiment, a contract programmed to execute predetermined processing to realize certificate issuing service. This smart contract 110 performs predetermined processing in response to a call from the node N on condition of payment of the GAS, and generates transaction data from the execution history. The smart contract 110 then arranges the generated transaction data in the mining pool. Note that the transaction data arranged in the mining pool is provided with a block header, mined by the miner, and then recorded in the blockchain.

The service provider A includes a server 200 that provides service to the user a. The server 200 stores, in a predetermined memory area, the registration information input by the user a via an App installed in his/her communication terminal, a web browser, or the like. This memory area may be various recording media such as a database, a file server, and a hard disk drive.

The service provider A may also include a special node N2 participating in the Ethereum network 100. That is, in the present embodiment, the node N2 that is one of the nodes N may be a node managed by the service provider A.

Furthermore, the service provider A includes a monitoring unit 210 that monitors addition of transaction data to the blockchain. This monitoring unit 210 may have a configuration of being incorporated in the node N2 or may have a configuration of being incorporated in another equipment (such as server 200) connected to the node N2 via a network.

The monitoring unit 210 is a configuration to manage the transaction data recorded in the blockchain, for example. For example, the monitoring unit 210 may manage the transaction data recorded in the blockchain by sequentially checking the transaction data held by the node N2, or may manage the transaction data recorded in the blockchain by monitoring the transaction data that is received by the node N2 by being broadcast to the Ethereum network 100. Alternatively, the management may be executed by another method.

### 2.2 Operation Example of Certificate Issuing Service

Next, a flow of the certificate issuing service using the information processing system illustrated in FIG. 1 will be described. Note that for the sake of simplicity, description of operations such as addition of a block header by the server managing the mining pool, mining by the miner, and answer checking by another miner will be omitted in the following.

The flow of the certificate issuing service according to the present embodiment roughly includes a phase until the user a records the application information in the blockchain, a phase until the service provider A approves the application information recorded in the blockchain, and a phase until the third party acquires a certificate of the application information recorded in the blockchain from the Ethereum network 100.

2.2.1 Flow Until User a Records Application Information in Blockchain

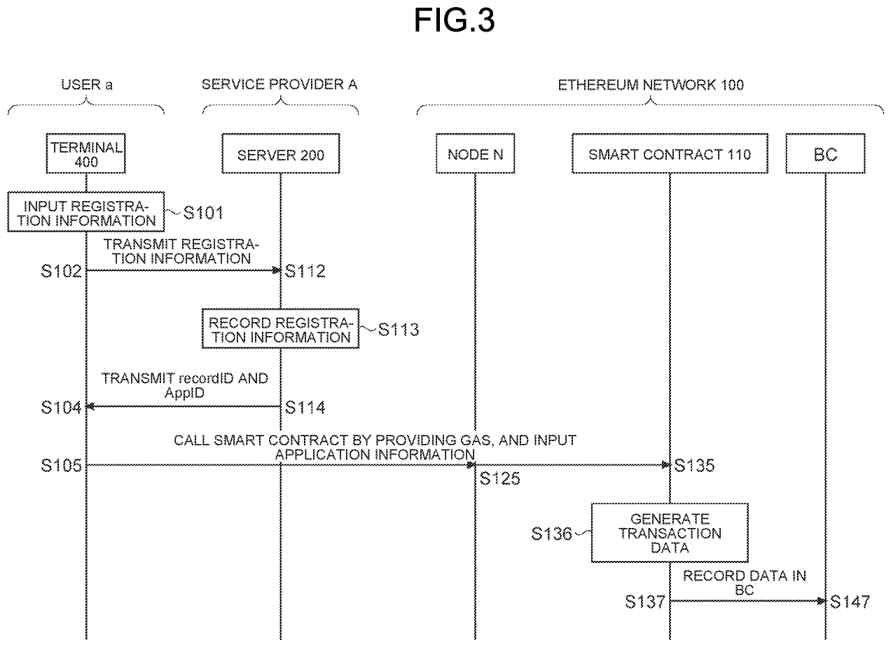

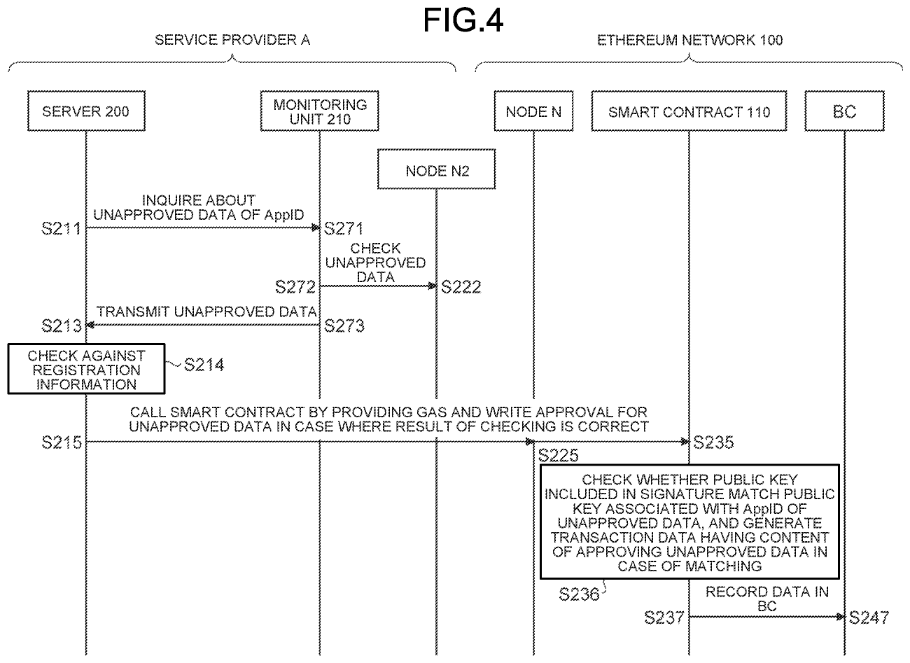

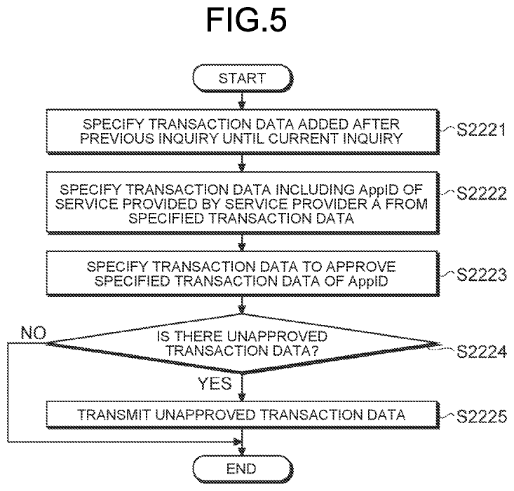

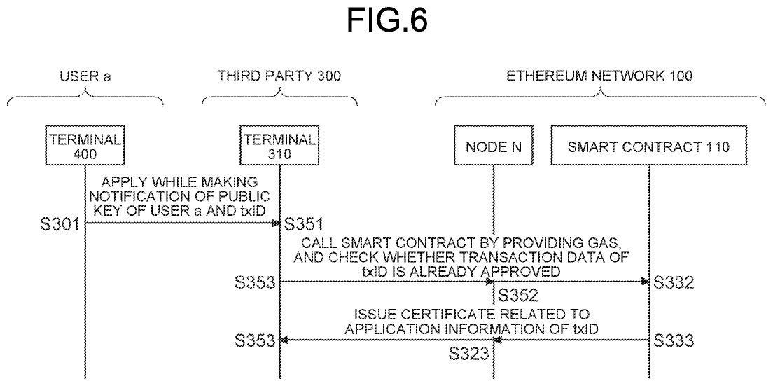

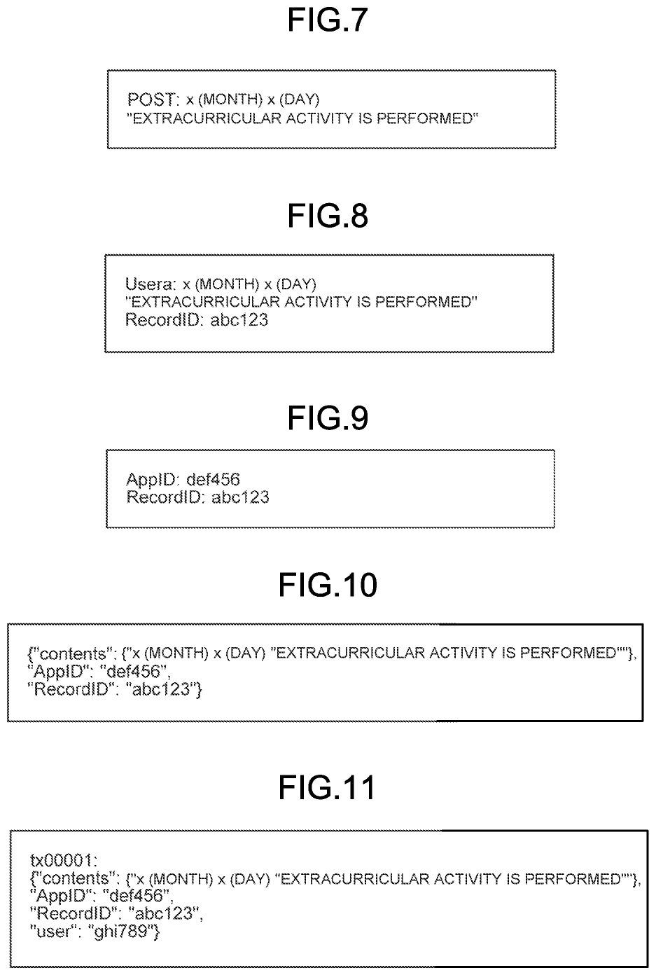

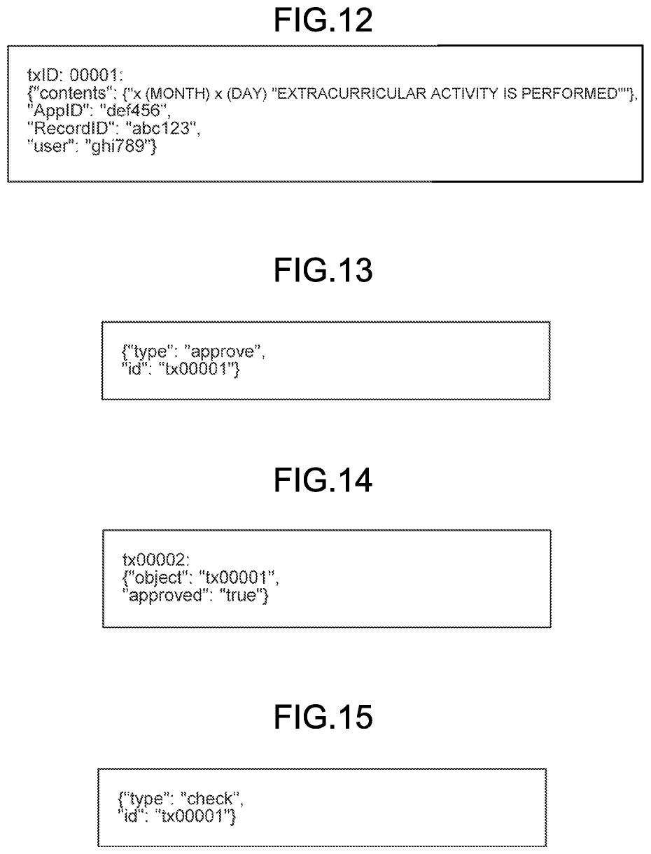

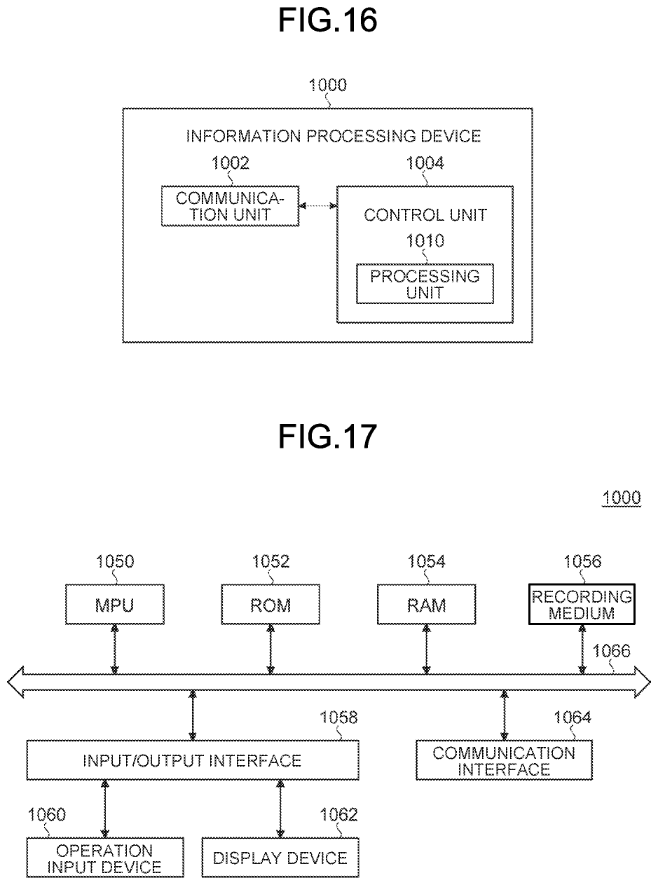

First, an example of the flow until the user a records the application information in the blockchain will be described with reference to FIG. 3, FIG. 2, and FIG. 7 to FIG. 11. FIG. 3 is a sequence diagram illustrating the example of the flow until the user records the application information in the blockchain according to the present embodiment.

As illustrated in FIG. 3 and FIG. 2, in the present phase, first, the user a starts a predetermined App on his/her terminal 400 and inputs the registration information to this App (Step S101 in FIG. 3). An example of the registration information is illustrated in FIG. 7. In FIG. 7, the registration information having contents that an “extracurricular activity is performed” by the user a on “×(month)×(day)” is illustrated.

The registration information input to the App is transmitted from the terminal 400 of the user a to the server 200 of the service provider A (Step S102→S112 in FIG. 3, and Step S1 in FIG. 2).

The server 200 that receives the registration information records the received registration information in the predetermined memory area (Step S113 in FIG. 3). At that time, the server 200 generates identification information for identifying the registration information arranged in the memory area (hereinafter, referred to as recordID), and records the registration information in association with information for specifying the user a (such as account of the App) and the recordID. In FIG. 8, an example of the information recorded in the service provider A is illustrated. In FIG. 8, information for specifying the user a (“Usera”) and the recordID (“abc123”) are recorded in association with the registration information (×(month)×(day) “extracurricular activity is performed”).

Then, the server 200 transmits the recordID provided to the registration information and identification information for identifying service (or App) used by the user a (hereinafter, referred to as AppID) to the terminal 400 of the user a (Step S114→S104 in FIG. 3, and Step S2 in FIG. 2). An example of the information transmitted from the server 200 to the terminal 400 is illustrated in FIG. 9. In FIG. 9, the AppID (“def456”) and the recordID (“abc123”) are transmitted from the server 200 to the terminal 400.

Subsequently, the user a accesses a node N from the terminal 400 (Step S105→S125 in FIG. 3, and Step S3 in FIG. 2). The node N accessed by the user a may be any node N participating in the Ethereum network 100. Then, the user a calls the smart contract 110 by providing the GAS from the node N, and inputs the application information to the read smart contract 110 (Step S125→S135 in FIG. 3, and Step S4 in FIG. 2). An example of the application information is illustrated in FIG. 10. In the example illustrated in FIG. 10, the registration information (“contents”: {“×(month)×(day) “extracurricular activity is performed””}), the AppID (“def456”), and the recordID (“abc123”) are included in the application information. Note that the application information input to the smart contract 110 is assumed to be signed by utilization of a private key held by the user a, for example.

The smart contract 110 to which the application information is input generates transaction data including the input application information. An example of the transaction data generated by the smart contract 110 is illustrated in FIG. 11. As illustrated in FIG. 11, the transaction data of an identifier “tx00001” includes the registration information (“contents”: {“×(month)×(day) “extracurricular activity is performed””}), the AppID (“def456”), the recordID (“abc123”), and a public key of the user a (“user”: “ghi789”). Note that instead of the AppID, a hash value of this AppID may be included in the transaction data.

The smart contract 110 then arranges the generated transaction data in the mining pool on the Ethereum network 100. Subsequently, when a block header is provided to this transaction data, a block generated thereby is mined, and a correct nonce is provided thereto, this block is recorded in the blockchain (Step S137→S147 in FIG. 3). In addition, ETHER as a reward is paid to the miner who finds the correct nonce.

2.2.2 Flow Until Service Provider a Approves Application Information Recorded in Blockchain

Next, an example of the flow until the service provider A approves the application information recorded in the blockchain will be described with reference to FIG. 4, FIG. 5, FIG. 2, and FIG. 12 to FIG. 14. FIG. 4 is a sequence diagram illustrating the example of the flow until the service provider A approves the application information recorded in the blockchain according to the present embodiment.

As illustrated in FIG. 4 and FIG. 2, in the present phase, in the service provider A, the server 200 first inquires of the monitoring unit 210 about transaction data that is not approved by the service provider A (hereinafter, referred to as unapproved transaction data or unapproved data) among pieces of transaction data including the identification information AppID (=“def456”) of the App provided by the service provider A (Step S211→S271 in FIG. 4, and Step S5 in FIG. 2).

On the other hand, the monitoring unit 210 accesses the memory area of the node N2 under the management of the service provider A, and checks the unapproved transaction data among pieces of transaction data stored in this memory area (Step S272→S222 in FIG. 4, and Step S6 in FIG. 2). An operation of specifying the unapproved transaction data by the monitoring unit 210 will be described later with reference to FIG. 5.

When specifying the unapproved transaction data, the monitoring unit 210 transmits the specified unapproved transaction data to the server 200 (Step S273→S213 in FIG. 4, and Step S7 in FIG. 2). FIG. 12 is a view illustrating an example of the unapproved transaction data transmitted from the monitoring unit 210 to the server 200. As illustrated in FIG. 12, the unapproved transaction data transmitted from the monitoring unit 210 to the server 200 includes identification information (txID: 0001) for uniquely identifying this transaction data, the registration information (“contents”: {“×(month)×(day) “extracurricular activity is performed””}), the AppID (“def456”), the recordID (“abc123”), and the public key of the user a (“user”: “ghi789”).

The server 200 that receives the unapproved transaction data from the monitoring unit 210 specifies the registration information stored in the own memory area from the recordID included in this transaction data, and checks whether the specified registration information matches the registration information in the transaction data (Step S214 in FIG. 4).

In a case where a result of the checking is correct, the server 200 accesses a node N (Step S215→S225 in FIG. 4, and Step S8 in FIG. 2). The node N accessed by the server 200 may be any node N participating in the Ethereum network 100. Then, the server 200 calls the smart contract 110 by providing the GAS from the node N, and inputs information for approving (“approve”) the corresponding transaction data (txID=“0001”) (hereinafter, referred to as approval information) to the read smart contract 110 (Step S225→S235 in FIG. 4, and Step S9 in FIG. 2). An example of the approval information is illustrated in FIG. 13. In the example illustrated in FIG. 13, information indicating the approval (“type”: “approve”) and identification information (“id”: “tx0001”) for specifying transaction data to be approved are included. Note that it is assumed that the approval information is signed by utilization of a private key held by the service provider A, for example.

The smart contract 110 to which the approval information is input specifies target transaction data from the txID (=“tx0001”) included in this approval information. Then, the smart contract 110 checks whether the public key associated with the AppID (=“def456”) (or hash value thereof) included in the specified transaction data matches a public key notified from the server 200 that is a caller, and generates transaction data having contents of approving the unapproved transaction data on the basis of the approval information in a case where the public keys match (Step S236). An example of the transaction data having contents indicating the approval is illustrated in FIG. 14. As illustrated in FIG. 14, the transaction data (“tx0002”) includes the txID (“tx0001”) specifying the transaction data to be approved, and contents indicating the approval (“approved”: “true”).

Note that it is assumed that the public key of the user a and the public key of the service provider A are shared by the user a, the service provider A, the third party, and the smart contract 110. Thus, the smart contract 110 manages the public key of the user a in association with the id (=“ghi789”) of the user a, and manages the public key of the service provider A in association with the AppID (=“def456”) (or hash value thereof) of the service provider A. Note that the association between the AppID and the public key is not limited to one-to-one, and a plurality of public keys may be associated with the one AppID (=“def456”), and a plurality of pieces of AppID may be associated with one public key.

The smart contract 110 then arranges the generated transaction data in the mining pool on the Ethereum network 100. Subsequently, when a block header is provided to this transaction data, a block generated thereby is mined, and a correct nonce is provided thereto, this block is recorded in the blockchain (Step S237→S247 in FIG. 4). In addition, ETHER as a reward is paid to the miner who finds the correct nonce.

Note that in the present example, although the registration information held on a side of the server 200 and the registration information in the unapproved transaction data match each other as a condition of approval of the transaction data, such a condition is not a limitation. That is, even in a case where the registration information held on the side of the server 200 does not match the registration information in the unapproved transaction data, the transaction data may be approved in a case where a predetermined condition is satisfied. For example, in a case where the service provider A gives the user a certain test question and the user a records transaction data including an answer to this test question into the blockchain, the server 200 may record, on the blockchain, approval that this transaction data including the answer is answered by the user a with respect to the question asked by the service provider A.

2.2.2.1 Operation Example of Specifying Unapproved Transaction Data by Monitoring Unit 210

FIG. 5 is a flowchart illustrating an example of an operation of specifying the unapproved transaction data which operation is executed by the monitoring unit 210 in Step S222 of FIG. 4.

As illustrated in FIG. 5, in the present operation, the monitoring unit 210 first specifies transaction data added to the blockchain after the previous inquiry until the current inquiry by the server 200 (Step S2221).

Next, the monitoring unit 210 specifies transaction data including the AppID of the service provided by the service provider A from the specified transaction data (Step S2222). In addition, the monitoring unit 210 further specifies transaction data having contents indicating approval of the transaction data specified in Step S2222 (Step S2223).

Then, the monitoring unit 210 determines whether there is unapproved transaction data as a result of the specifying processing in Step S2222 to S2223 (Step S2224), and ends the present operation in a case where there is none (NO in Step S2224). On the other hand, in a case where there is unapproved transaction data (YES in Step S2224), the monitoring unit 210 transmits the specified unapproved transaction data to the server 200 (Step S2225), and ends the present operation.

Note that a pull-type configuration in which the server 200 makes an inquiry to the monitoring unit 210 and acquires unapproved transaction data (Step S211 to S213 in FIG. 4 and Step S5 to S7 in FIG. 2) has been exemplified in FIG. 5, FIG. 1, and FIG. 4. However, such a configuration is not a limitation. For example, a push-type configuration in which the monitoring unit 210 transmits unapproved transaction data to the server 200 when receiving this unapproved transaction data may be adopted.

2.2.3 Flow Until Third Party Acquires Certificate of Application Information Recorded in Blockchain from Ethereum Network

Next, an example of the flow until the third party acquires the certificate of the application information recorded in the blockchain from the Ethereum network 100 will be described with reference to FIG. 6, FIG. 2, and FIG. 15. FIG. 6 is a sequence diagram illustrating the example of the flow until the third party acquires the certificate of the application information recorded in the blockchain from the Ethereum network according to the present embodiment.

As illustrated in FIG. 6 and FIG. 2, in the present phase, first, the user a applies for the registration information to the third party (Step S301→S351 in FIG. 6, and Step S10 in FIG. 2). In this application, the user a notifies the third party of his/her id (=“ghi456”), his/her public key, and the txID (=“tx0001” or “tx0002”) for specifying the transaction data including the registration information from the blockchain.

The third party accesses a node N from the own terminal 310 (Step S353→S332 in FIG. 6, and Step S11 in FIG. 2). The node N accessed by the terminal 310 may be any node N participating in the Ethereum network 100. Then, the third party calls the smart contract 110 by providing the GAS from the node N, specifies transaction data corresponding to the txID notified to the read smart contract 110 at the time of the application (txID=“0001”) or transaction data approving the transaction data of this txID (txID=“0002”), and checks whether the transaction data of the txID (=“0001”) including the registration information registered by the user a is already approved (Step S352→S332 in FIG. 6).

In a case where the transaction data of the txID (=“0001”) is already approved, the smart contract 110 issues the certificate to the terminal 310 of the third party via the node N (Step S333→S323→S353 in FIG. 6). An example of the certificate issued by the smart contract 110 is illustrated in FIG. 15. As illustrated in FIG. 15, the certificate includes check information (“type”: “check”) indicating that the transaction data of the txID (=“0001”) is already approved, and identification information (“id”: “tx0001”) for specifying the target transaction data.

Through the above procedure, the third party can check that the contents applied by the user are approved on the Ethereum network 100.

### 3. Schematic Configuration Example of Information Processing Device

The terminals 400 and 310, the server 200, and each of the nodes N in the above-described embodiment may be realized by, for example, an information processing device 1000 described below.

FIG. 16 is a block diagram illustrating an example of a configuration of the information processing device 1000 according to the present embodiment. The information processing device 1000 includes, for example, a communication unit 1002 and a control unit 1004.

The control unit 1004 includes, for example, an MPU or the like, and plays a role of controlling the entire information processing device 1000. Furthermore, the control unit 1004 includes, for example, a processing unit 1010, and plays a leading role in performing processing related to the information processing method according to the present embodiment. Note that the monitoring unit 210 in the above embodiment may be realized by the processing unit 1010.

The communication unit 1002 is a communication means included in the information processing device 1000, and performs wireless or wired communication with an external device included in the peer-to-peer network according to the present embodiment. Furthermore, the communication unit 1002 may have a function of performing wireless or wired communication with an arbitrary external device such as a server via an arbitrary network (or directly), for example. Also, communication of the communication unit 1002 is controlled by the control unit 1004, for example.

Here, examples of the communication unit 1002 include a communication antenna and an RF circuit, a LAN terminal and a transmission/reception circuit, and the like. However, the configuration of the communication unit 1002 is not limited to the above. For example, the communication unit 1002 can have a configuration corresponding to an arbitrary standard capable of performing communication, such as a USB terminal and a transmission/reception circuit, or an arbitrary configuration capable of communicating with an external device via a network. Furthermore, the communication unit 1002 may have a configuration capable of performing communication with one or more external devices or the like by a plurality of communication methods.

Also, the information processing device 1000 may include, for example, a read only memory (ROM) (not illustrated), a random access memory (RAM) (not illustrated), a storage unit (not illustrated), an operation unit that can be operated by a user (not illustrated), a display unit that displays various screens on a display screen (not illustrated), and the like. The information processing device 1000 connects the above-described components by a bus as a transmission path of data, for example.

The ROM (not illustrated) stores control data such as a program and calculation parameter used by the control unit 1004. The RAM (not illustrated) temporarily stores the program or the like executed by the control unit 1004.

The storage unit (not illustrated) is a storage means included in the information processing device 1000 and stores, for example, various kinds of data such as data related to the information processing method according to the present embodiment, and various applications. The data related to the information processing method according to the present embodiment is, for example, an encryption key held by the user a or the service provider A, and a table in which contents that may be indicated by second data are associated with numerical values. Here, examples of the storage unit (not illustrated) include a magnetic recording medium such as a hard disk, a nonvolatile memory such as a flash memory, and the like. Furthermore, the storage unit (not illustrated) may be detachable from the information processing device 1000.

As the operation unit (not illustrated), there is an operation input device (described later). Also, as the display unit (not illustrated), there is a display device (described later).

### 4. Hardware Configuration Example of Information Processing Device

Furthermore, the information processing device 1000 may include, for example, a hardware configuration exemplified below.

FIG. 17 is a view for describing an example of the hardware configuration of the information processing device 1000 according to the present embodiment. The information processing device 1000 includes, for example, a micro processing unit (MPU) 1050, a ROM 1052, a RAM 1054, a recording medium 1056, an input/output interface 1058, an operation input device 1060, a display device 1062, and a communication interface 1064. Furthermore, the information processing device 1000 connects the components by a bus 1066 as a transmission path of data, for example.

The MPU 1050 includes, for example, one or more processors including an arithmetic circuit such as an MPU, various processing circuits, and the like, and functions as the control unit 1004 that controls the entire information processing device 1000. Furthermore, the MPU 1050 functions as, for example, a processing unit 1010 (described later) in the information processing device 1000. Note that the processing unit 1010 may include a dedicated (or general-purpose) circuit (such as processor separate from the MPU 1050, or the like) capable of realizing processing by the processing unit 1010.

The ROM 1052 stores control data such as a program and calculation parameter used by the MPU 1050. The RAM 1054 temporarily stores the program or the like executed by the MPU 1050, for example.

The recording medium 1056 functions as a storage unit (not illustrated) and stores, for example, various kinds of data such as data related to the information processing method according to the present embodiment, and various applications. The data related to the information processing method according to the present embodiment is, for example, an electronic signature using an encryption key. Here, examples of the recording medium 1056 include a magnetic recording medium such as a hard disk, and a nonvolatile memory such as a flash memory. Furthermore, the recording medium 1056 may be detachable from the information processing device 1000.

The input/output interface 1058 connects, for example, the operation input device 1060, and the display device 1062. The operation input device 1060 functions as an operation unit (not illustrated), and the display device 1062 functions as a display unit (not illustrated). Here, examples of the input/output interface 1058 include a universal serial bus (USB) terminal, a digital visual interface (DVI) terminal, a high-definition multimedia interface (HDMI) (registered trademark) terminal, various processing circuits, and the like.

Furthermore, for example, the operation input device 1060 is provided on the information processing device 1000 and is connected to the input/output interface 1058 inside the information processing device 1000. For example, the operation input device 1060 is a button, an arrow key, a rotary selector such as a jog dial, or a combination thereof.

Furthermore, for example, the display device 1062 is provided on the information processing device 1000, and is connected to the input/output interface 1058 inside the information processing device 1000. For example, the display device 1062 is a liquid crystal display, an organic electro-luminescence display (organic EL display) (also referred to as organic light emitting diode display (OLED display)), or the like.

Note that it goes without saying that the input/output interface 1058 can be connected to an external device such as an operation input device (such as keyboard, mouse, or the like) outside the information processing device 1000, or an external display device. Furthermore, the display device 1062 may be a device on which a display and user operation can be performed, such as a touch panel.

The communication interface 1064 is a communication means included in the information processing device 1000, and functions as a communication unit 1002 to perform wireless or wired communication with an external device included in the peer-to-peer network according to the present embodiment. Furthermore, the communication interface 1064 may have a function of performing wireless or wired communication with an arbitrary external device such as a server via an arbitrary network (or directly), for example. Here, the communication interface 1064 is, for example, a communication antenna and a radio frequency (RF) circuit (wireless communication), an IEEE 802.15.1 port and a transmission/reception circuit (wireless communication), an IEEE 802.11 port and a transmission/reception circuit (wireless communication), or a local area network (LAN) terminal and a transmission/reception circuit (wired communication).

The information processing device 1000 performs the processing related to the information processing method according to the present embodiment with the configuration illustrated in FIG. 16, for example. Note that the hardware configuration of the information processing device 1000 according to the present embodiment is not limited to the configuration illustrated in FIG. 17.

For example, the information processing device 1000 may not include the communication interface 1064 in a case of performing communication with an external device or the like via a connected external communication device. Furthermore, the communication interface 1064 may have a configuration capable of performing communication with one or more external devices or the like by a plurality of communication methods.

Furthermore, the information processing device 1000 can have a configuration that does not include the recording medium 1056, the operation input device 1060, and the display device 1062, for example.

Furthermore, for example, a part or whole of the configuration illustrated in FIG. 17 (or configuration according to a modification example) may be realized by one or more integrated circuits (IC).

Although the information processing device has been described above as the present embodiment, the present embodiment is not limited to such a form. The present embodiment can be applied to various kinds of equipment that can perform the processing related to the information processing method according to the present embodiment and that are, for example, a computer such as a personal computer (PC) or a server, and the like. Furthermore, the present embodiment can be also applied to, for example, a processing IC that can be incorporated in equipment as described above.

Furthermore, the information processing device according to the present embodiment may be applied to a processing system on the premise of connection to a network (or communication between devices), such as cloud computing. As an example of the processing system in which the processing related to the information processing method according to the present embodiment is performed, there is a “system in which a part of the processing of the certificate issuing service related to the information processing method according to the present embodiment is performed by one device included in the processing system and processing other than the part of the processing of the certificate issuing service related to the information processing method according to the present embodiment is performed by another device included in the processing system”, for example.

### 5. Program According to Present Embodiment

The information processing device 1000 included in each of the terminals 400 and 310, the server 200, the monitoring unit 210, and the nodes N according to the present embodiment may function as a device that executes processing performed by each thereof by executing a predetermined program, for example.

Such a program may be distributed via a recording medium such as a CD-ROM, or may be distributed via a network such as the Internet.

### 6. Conclusion

As described above, according to the present embodiment, in the service using the public-type peer-to-peer network capable of executing the smart contract, the registration information recorded in the blockchain is signed by the private key of the user a and encrypted. This makes it possible to maintain confidentiality of data in the service using the public-type blockchain.

Furthermore, in the present exemplary embodiment, in a case where the registration information recorded in the blockchain by the user a is correct, the transaction data including this registration information is approved by the service provider A. As a result, authenticity of the registration information recorded in the blockchain by the user a is secured. Thus, it is possible to improve reliability of the certificate for the registration information provided by the smart contract of the peer-to-peer network.

Although an embodiment of the present disclosure has been described above, the technical scope of the present disclosure is not limited to the above-described embodiment as it is, and various modifications can be made within the spirit and scope of the present disclosure. Also, components of different embodiments and modification examples may be arbitrarily combined.

Furthermore, an effect in each of the embodiments described in the present description is merely an example and is not a limitation, and there may be a different effect.

Note that the present technology can also have the following configurations.

(1)

An information processing system comprising:

a service providing unit that provides a predetermined service to a user;

a recording unit that holds first registration information registered by the user in the service providing unit according to the predetermined service, and

a monitoring unit that monitors whether first transaction data including first identification information for specifying the predetermined service is recorded in a public blockchain, wherein

the monitoring unit transmits the first transaction data to the service providing unit, and

in a case where second registration information included in the first transaction data received from the monitoring unit matches the first registration information held in the recording unit, the service providing unit generates data for recording second transaction data for approving the first transaction data into the public blockchain.

(2)

The information processing system according to (1), wherein by monitoring transaction data held by at least one node among a plurality of nodes included in the public blockchain, the monitoring unit monitors whether the first transaction data including the first identification information is recorded in the public blockchain.

(3)

The information processing system according to (2), wherein the monitoring unit monitors whether the first transaction data including the first identification information is recorded in the public blockchain by referring to the transaction data held by the at least one node in response to an inquiry from the service providing unit.

(4)

The information processing system according to (2), wherein by monitoring transaction data broadcasted to the public blockchain and received by the at least one node, the monitoring unit monitors whether the first transaction data including the first identification information is recorded in the public blockchain.

(5)

The information processing system according to any one of (1) to (4), wherein the public blockchain is an Ethereum network.

(6)

The information processing system according to any one of (1) to (5), wherein

the public blockchain is a network capable of executing a smart contract, and

the service providing unit records the second transaction data in the public blockchain by calling the smart contract from one node of a plurality of nodes included in the public blockchain.

(7)

The information processing system according to (6), wherein the smart contract is a Turing-complete type.

(8)

The information processing system according to (6) or (7), wherein

the service providing unit notifies the user of second identification information for specifying a recording position of the first registration information in the recording unit,

the user records the first transaction data including the first registration information and the second identification information in the public blockchain by calling the smart contract from the one node of the plurality of nodes, and

the service providing unit specifies the recording position of the first registration information in the recording unit on a basis of the second identification information included in the first transaction data received from the monitoring unit, checks the first registration information recorded at the specified recording position against the second registration information included in the first transaction data received from the monitoring unit, and generates the data for recording the second transaction data into the public blockchain in a case where the first registration information matches the second registration information.

(9)

The information processing system according to any one of (6) to (8), wherein in a case where the first transaction data is approved by the second transaction data, the smart contract issues information certifying authenticity of the second registration information included in the first transaction data in response to an inquiry accompanied by third identification information that identifies at least one of the first transaction data and the second transaction data.

(10)

An information processing device comprising: a processing unit that monitors whether transaction data including identification information for specifying a predetermined service is recorded in a public blockchain.

(11)

An information processing method comprising steps of:

providing a predetermined service from a service providing unit to a user;

holding first registration information registered in the service providing unit by the user according to the predetermined service;

monitoring whether first transaction data including first identification information for specifying the predetermined service is recorded in a public blockchain;

transmitting the first transaction data to the service providing unit in a case where the first transaction data including the first identification information is recorded in the public blockchain, and

recording second transaction data for approving the first transaction data into the public blockchain in a case where second registration information included in the received first transaction data matches the held first registration information.

### REFERENCE SIGNS LIST

100 ETHEREUM NETWORK
110 SMART CONTRACT
200 SERVER
210 MONITORING UNIT
300 THIRD PARTY
310, 400 TERMINAL
N1, N2, N3, N4, . . . NODE
A SERVICE PROVIDER
a USER
1000 INFORMATION PROCESSING DEVICE
1002 COMMUNICATION UNIT
1004 CONTROL UNIT
1010 PROCESSING UNIT

1. An information processing system comprising:
a service providing unit that provides a predetermined service to a user;
a recording unit that holds first registration information registered by the user in the service providing unit according to the predetermined service, and
a monitoring unit that monitors whether first transaction data including first identification information for specifying the predetermined service is recorded in a public blockchain, wherein
the monitoring unit transmits the first transaction data to the service providing unit, and
in a case where second registration information included in the first transaction data received from the monitoring unit matches the first registration information held in the recording unit, the service providing unit generates data for recording second transaction data for approving the first transaction data into the public blockchain.

2. The information processing system according to claim 1, wherein by monitoring transaction data held by at least one node among a plurality of nodes included in the public blockchain, the monitoring unit monitors whether the first transaction data including the first identification information is recorded in the public blockchain.

3. The information processing system according to claim 2, wherein the monitoring unit monitors whether the first transaction data including the first identification information is recorded in the public blockchain by referring to the transaction data held by the at least one node in response to an inquiry from the service providing unit.

4. The information processing system according to claim 2, wherein by monitoring transaction data broadcasted to the public blockchain and received by the at least one node, the monitoring unit monitors whether the first transaction data including the first identification information is recorded in the public blockchain.

5. The information processing system according to claim 1, wherein the public blockchain is an Ethereum network.

6. The information processing system according to claim 1, wherein
the public blockchain is a network capable of executing a smart contract, and
the service providing unit records the second transaction data in the public blockchain by calling the smart contract from one node of a plurality of nodes included in the public blockchain.

7. The information processing system according to claim 6, wherein the smart contract is a Turing-complete type.

8. The information processing system according to claim 6, wherein
the service providing unit notifies the user of second identification information for specifying a recording position of the first registration information in the recording unit,
the user records the first transaction data including the first registration information and the second identification information in the public blockchain by calling the smart contract from the one node of the plurality of nodes, and
the service providing unit specifies the recording position of the first registration information in the recording unit on a basis of the second identification information included in the first transaction data received from the monitoring unit, checks the first registration information recorded at the specified recording position against the second registration information included in the first transaction data received from the monitoring unit, and generates the data for recording the second transaction data into the public blockchain in a case where the first registration information matches the second registration information.

9. The information processing system according to claim 6, wherein in a case where the first transaction data is approved by the second transaction data, the smart contract issues information certifying authenticity of the second registration information included in the first transaction data in response to an inquiry accompanied by third identification information that identifies at least one of the first transaction data and the second transaction data.

10. An information processing device comprising: a processing unit that monitors whether transaction data including identification information for specifying a predetermined service is recorded in a public blockchain.

11. An information processing method comprising steps of:
providing a predetermined service from a service providing unit to a user;
holding first registration information registered in the service providing unit by the user according to the predetermined service;
monitoring whether first transaction data including first identification information for specifying the predetermined service is recorded in a public blockchain;
transmitting the first transaction data to the service providing unit in a case where the first transaction data including the first identification information is recorded in the public blockchain, and
recording second transaction data for approving the first transaction data into the public blockchain in a case where second registration information included in the received first transaction data matches the held first registration information.
